(19) United States
(12) Patent Application Publication
(10) Pub. No.: US 2022/0354141 A1
(43) Pub. Date: Nov. 10, 2022

(54) METHOD AND SYSTEM FOR SMOKING FOOD

(71) Applicant: Low and Slow Smoked Snacks, LLC, Dallas, TX (US)

(72) Inventors: Jared Drinkwater, Dallas, TX (US); Michael Zbuchalski, Plano, TX (US)

(21) Appl. No.: 17/507,231

(22) Filed: Oct. 21, 2021

Related U.S. Application Data
(60) Provisional application No. 63/186,503, filed on May 10, 2021.

(51) Int. Cl. A23B 4/052

(52) U.S. Cl. CPC A23B 4/0523

(57) ABSTRACT

Method for smoking a farinaceous food. A first step comprises burning wood to produce smoke at a first location in a first space. A second step comprises conveying the smoke to a second location in a second space. A third step comprises providing fluid communication between a food in the second space and the smoke in the first space to provide a smoked food.

### CROSS-REFERENCE TO RELATED APPLICATIONS

This application claims priority to U.S. Provisional Application No. 63/186,503, filed on May 10, 2021 and entitled “METHOD AND SYSTEM FOR SMOKING FOOD,” which is hereby incorporated by reference in its entirety as an example.

### BACKGROUND OF THE INVENTION

### Technical Field

The present invention relates to a method and system for providing a snack food product, optionally a low moisture snack food product, with real smoke flavor. In some aspects, the invention also relates to providing a snack food product, for example, chips, with real smoke flavor by placing a snack food, optionally a low moisture snack food, in fluid communication with smoke created remotely from the snack food, which smoke can also be cooled.

### Description of Related Art

Existing methods and systems for smoking food are lacking in various desirable qualities. For example, smoking food can result in the loss of desirable product characteristics such as crispiness, can cause off-flavors, or can result in an undesirably short shelf-life. Similarly, methods and systems that apply smoke flavoring to food without actually smoking the food also lack certain desirable qualities. For example, smoke-flavored products that have not actually been smoked can have a flavor that is different or less desirable than the flavor of smoked products. Thus, existing methods and systems for applying smoke to food products are lacking in various desirable characteristics.

### SUMMARY OF SELECTED EMBODIMENTS

In accordance with a first embodiment, a method for smoking a farinaceous food is provided. The method comprises several steps. A first step comprises burning wood to produce smoke at a first location in a first space. A second step comprises conveying the smoke to a second location in a second space. A third step comprises providing fluid communication between a farinaceous food in the second space and the smoke in the first space to provide a smoked food.

Other aspects, embodiments and features of the disclosure will become apparent from the following detailed description when considered in conjunction with the accompanying drawings. The accompanying figures are schematic and are not intended to be drawn to scale. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

FIG. 1 is a schematic illustration depicting an example of a process and system for providing a food product with smoke flavor.

FIG. 2 is a schematic illustration that depicts a view from above a horizontal section of the smoker chamber that is illustrated FIG. 1 as viewed from the front.

FIG. 3 is a schematic flow chart depicting an example of a method for providing a food product with smoke flavor.

FIGS. 4 and 5 are schematic flow charts depicting an example of a process and system for providing a food product with smoke flavor.

### DETAILED DESCRIPTION

In some embodiments, the methods and systems described in the present application solve one or more problems or provide one or more advantageous characteristics to a method or product. For example, in some embodiments, the methods and systems can provide: a smoked food, a wood-smoked food, a naturally wood-smoked food, a shelf-stable food, a high quality BBQ food, chips, potato chips, a food with unique organoleptic properties, a food with a unique or desired taste profile, a food with a unique or desired aroma profile, a food with a unique or desired texture profile, a food with a low moisture content, a crunchy food, or any combination thereof. In some embodiments the method can provide a manufacturing process, a commercial-scale process, a smoking process, a reduced-temperature smoking process, or a cold-smoking process that can provide a food with any of the characteristics described for food in this disclosure.

Snack foods are one example of the foods that can be manufactured using the processes described in the present disclosure. Examples of snack foods include, but are not limited to, fried snacks, baked snacks, extruded pellets, and air popped snacks. These and other foods can be used in a natural wood-smoking process as described in this disclosure.

In some embodiments, use of natural wood or woods, including but not limited to Hickory, Mesquite, Oak, Cherry, Applewood, or any combination thereof, to include smoke as part of the product formulation imparts a unique taste and aroma not found in currently available packaged food products, for example, packaged snack foods.

Without being bound by theory, the unique taste and aroma imparted to food as a result of smoking wood are believed to be due to the presence of compounds including, but not limited to, acids (tangy), esters (fruity), phenols (spicy), and furans (nutty) in the smoke. These aromatic compounds are produced through the thermal degradation of burning the organic polymers of natural wood. For example, pyrolyisis of lignin during the wood burning process delivers smoky flavors that some consumers greatly appreciate. When lignin burns, it produces a range of aromatic compounds, and some of the most important compounds are 2-methoxy-substitute phenols, namely guaiacol, which produces smoky flavors, and syringol, which produces smoky smell and aroma.

Some consumers prefer the smoke aroma and smoke flavor of packaged food products (e.g., snack foods) made using a true wood-smoking process when compared to alternative commercially available products. In some embodiments, smoke aroma can be present in the headspace of a packaged food product and detectable by consumers after opening a package for the packaged food product. This smoke aroma can distinguish a smoked food from imitations that do not actually involve contacting the food with smoke.

Although smoking a food to provide the food with a real smoke flavor and aroma can be desirable, the resulting changes to other desirable product characteristics, for example, texture and shelf-life, can result in a product that is not commercially viable. Advantageously, some methods described in this disclosure can provide a food with a real smoke aroma and/or flavor while also maintaining other desirable characteristics of the food. In some embodiments, novel manufacturing methods reduce or eliminate excessive temperature and moisture content that shorten shelf-life through oxidative rancidity. Further, some embodiments reduce or eliminate staling caused by a high moisture content of the food when it is packaged.

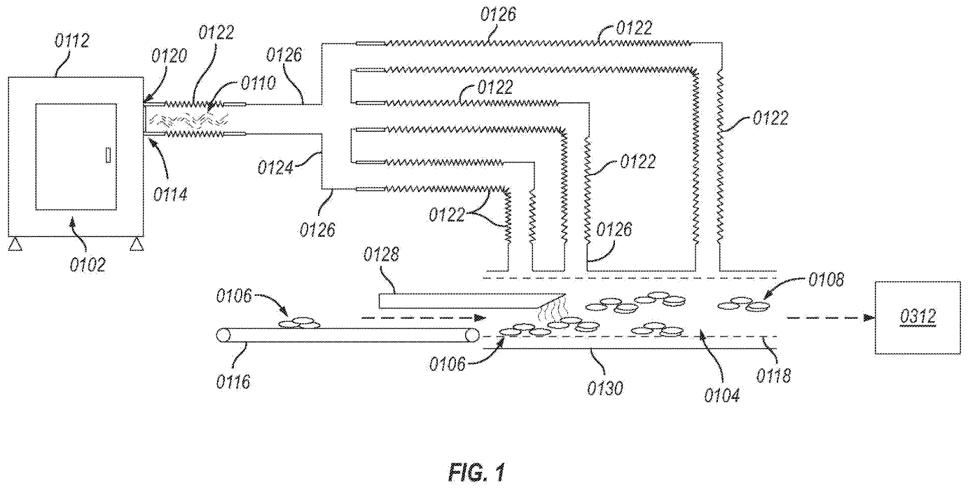

Referring now to FIG. 1 through FIG. 3, an embodiment of a method for smoking food 0106 will now be described. The method comprises several steps. A first step comprises burning 0304 wood to produce smoke 0110 at a first location in a first space 0102. As examples, the wood can be Hickory, Mesquite, Oak, Cherry, Applewood, or any combination thereof. In some embodiments, the step of burning 0304 the wood to produce the smoke 0110 at the first location comprises burning 0304 the wood in a first chamber 0112.

In some embodiments, the first chamber 0112 is provided with an outlet 0114 that can be opened to permit smoke 0110 to be discharged from the first chamber 0112 and closed to impede passage of the smoke 0110 from the first chamber 0112. For example, the outlet can comprise or be equipped with a flue damper 0120.

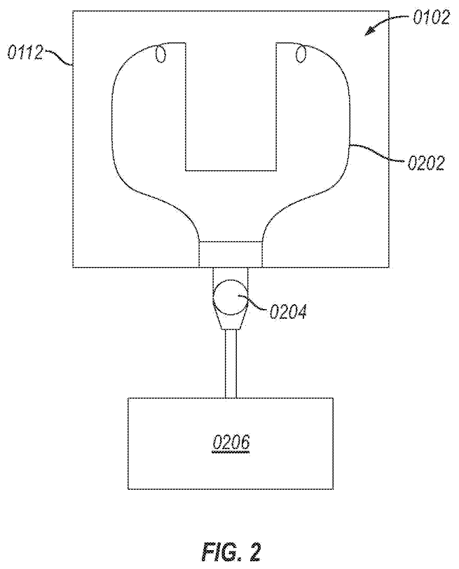

With reference now to FIG. 2, in some embodiments, the wood is burned using an electric heating element 0202, and optionally the electric heating element 0202 is provided with a thermostat 0204 to control the temperature at the first location, the temperature of the heating element, the temperature at which the wood is burned, the temperature at which smoke 0110 is created, or any combination thereof. In some embodiments, the thermostat can be used to set the temperature to 176.7° C. (350° F.), to 218.3° C. (425° F.), to 315.6° C. (600° F.), to 398.9° C. (750° F.), or to a range of values from 176.7° C. (350° F.) to 398.9° C. (750° F.) or from 218.3° C. (425° F.) to 315.6° C. (600° F.). Although, in additional embodiments, the thermostat can set the temperature at any temperature that is sufficiently hot to result in smoke. Optionally, the thermostat can be set at a minimum temperature that is as low as possible while also hot enough to result in sufficient smoke to provide the food with a desired flavor within 1 to 5 minutes of contact with the smoke. The electric heating element can be powered by a power source 0206, for example, a 110 volt outlet, a battery or any other power source.

With reference again to FIG. 1, a second step of the illustrated method comprises conveying 0306 the smoke 0110 to a second location in a second space 0104. In some embodiments, the conveying step comprises conveying 0306 the smoke 0110 to the second location via a manifold 0124 in fluid communication with the first chamber 0112 at the first location, the manifold 0124 being in fluid communication with a plurality of conduits, each conduit 0126 being in fluid communication with the second space 0104, and the second space 0104 being at least partially bounded by a tumbler or a rotary drum 0118, which can be configured to facilitate the application of seasoning to the food 0106 while the food 0106 is in contact with the smoke or can be configured to facilitate the exposure of multiple surfaces of the food to the smoke regardless of whether seasoning is also applied.) In some embodiments, the conduit 0126 or the plurality of conduits can comprise flexible piping 0122. In some embodiments, in addition to or as an alternative to being partially bounded by the rotary drum 0118, the second space 0104 can be at least partially enclosed by a housing 0130 (e.g., second chamber), which can retain smoke 0110 to facilitate contact between the smoke 0110 and the food 0106. In some embodiments, in addition to or as an alternative to a tumbler or rotary drum, the second space 0104 is at least partially bounded by a housing, which can be for an agitator (e.g., as provided by a mixer, reorientation apparatus, inverter, tumbler or rotary drum 0118, which can configured to facilitate the application of seasoning to the food 0106 while the food 0106 is in contact with the smoke or which can be configured to facilitate the exposure of multiple surfaces of the food to the smoke regardless of whether seasoning is also applied). A further example of an agitator is a multiple pass conveyor, which can, for example, comprise a plurality of conveyors. For example, the first conveyor in the plurality of conveyors can be configured to discharge the food resting on a first set of surfaces of the food to a second conveyor in such a way that the food is reoriented and optionally so that the food rests on a second set of surfaces on the second conveyor, thereby facilitating exposure of a plurality of surfaces of the food to the smoke. In some embodiments, the second conveyor can be configured to discharge the food resting on the second set of surfaces of the food to a third conveyor in such a way that the food is reoriented and so that the food rests on a third set of surfaces on the third conveyor, optionally the third set of surfaces comprise or generally correspond to the first set of surfaces, thereby facilitating exposure of a plurality of surfaces of the food to the smoke.

With further reference to FIG. 1, a third step of the illustrated method comprises providing 0308 fluid communication between a food 0106 in the second space 0104 and the smoke 0110 in the first space 0102 to provide a smoked food 0108. Although the steps can be initiated in the specified order, the steps can also overlap. For example, the first step can occur simultaneously with the second step. Additionally, the third step can occur simultaneously with the second step and the first step. Furthermore, in some embodiments, the step of providing 0308 fluid communication between a food 0106 in the second space 0104 and the smoke 0110 in the first space 0102 can comprise agitating the food using an agitator, for example, any agitator described in this disclosure. Also, in some embodiments, the step of providing 0308 fluid communication between a food 0106 in the second space 0104 and the smoke 0110 in the first space 0102 can comprise filtering the smoke before it reaches the food so that the smoke contacting the food is a filtered smoke. In some embodiments, it can be desirable to preserve aromatic portions of the smoke that contribute to flavors deemed desirable by some consumers while filtering out particulates (e.g., tar) in the smoke above a specified particle size. In some embodiments, the step of filtering the smoke can comprise passing the smoke through a filter (e.g., HEPA filter #12) to provide a filtered smoke. In some embodiments, a filter can be located in the manifold 0124, the conduit 0126 or in each of the plurality of conduits 0126.

In some embodiments, the method also comprises the step of cooling the smoke 0110 to a temperature in the range from 0 to 124° C. before the smoke 0110 contacts the food 0106 at the second location. This can occur, for example, as part of the conveying 0306 step. The cooling can be passive or use a cooler. In some embodiments, the smoke 0110 can be cooled to a temperature near ambient temperature (e.g., room temperature) before the smoke 0110 contacts the food 0106 at the second location.

In some embodiments, the method comprises the step of contacting the food 0106 with the smoke 0110 for 1 to 5 minutes or 1 to 3 minutes. In order to provide a food with a desired shelf-life and maintain desired organoleptic properties, it can be useful to limit the amount of time that the smoke is in contact with food. Generally, as the temperature of the smoke increases, it can be useful for the time that the food spends in contact with the smoke to be shorter, for example, to avoid causing crunchy products to become soggy or soft, or to help maintain a longer shelf-life. In some embodiments, the step of contacting the food 0106 with the smoke 0110 occurs at a temperature of no more than 121.1 or 79.4° C. (250 or 175° F.). Optionally, the step of contacting the food 0106 with the smoke 0110 occurs at a temperature that is at least ambient temperature or room temperature or at least greater than 0° C. (32° F.).

In some embodiments, the food 0106 that is smoked can be a farinaceous food, for example, a baked or fried potato chip. Accordingly, the food 0106 can have a relatively low moisture content of 0.5 to 3 wt. %, and it can be desirable for the smoked food to have a moisture content in the same range to maintain desired organoleptic properties and shelf-life. Accordingly, in some embodiments, the smoked food 0108 has a moisture content of 0.5 to 3 wt. %.

In some embodiments, the method comprises applying 0310 seasoning to the food 0106 before, during or after contacting the food 0106 with smoke 0110, thereby providing a finished food product that comprises the smoked food 0108. In the embodiments illustrated in FIG. 1, the seasoning is applied to the food 0106 while the food is contacted with smoke 0110. The application of seasoning can be accomplished, for example, by discharging seasoning into contact with the food from a seasoning applicator (e.g., screw feeder, vibratory pan 0128, or any combination thereof). In some embodiments, the application of seasoning to the food can be facilitated by placing the food in contact with the seasoning in a perforated rotary drum 0118, and mixing the food and seasoning by rotating the drum 0118. In some embodiments, the application of seasoning to the food can be facilitated by placing the food in contact with the seasoning in any agitator described in this disclosure.

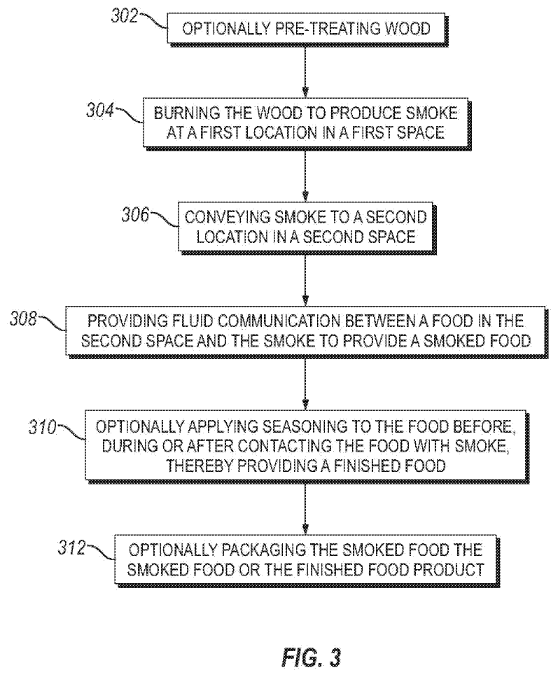

With reference to FIG. 3, in some embodiments, the method comprises packaging 0312 the smoked food or the finished food product.

With further reference to FIG. 3, in some embodiments, the method comprises pre-treating 0302 the wood before burning 0304 the wood. The pre-treating can comprise placing the wood in contact with water or an aqueous solution comprising water for 1 to 2 hours.

With reference again to FIG. 1, in some embodiments, the method comprises conveying the food 0106 to the second location on a conveyor belt 0116, the conveyor belt 0116 configured to deliver the food 0106 to a rotary drum 0118, the rotary drum 0118 configured to facilitate the application of seasoning to the farinaceous food 0106 while the farinaceous food 0106 is in contact with the smoke. In some embodiment, the method comprises conveying the food 0106 to the second location on a conveyor belt 0116, the conveyor belt 0116 configured to deliver the food 0106 to an agitator (e.g., rotary drum 0118), the agitator (e.g. the rotary drum 0118) configured to facilitate the application of seasoning to the farinaceous food 0106 while the farinaceous food 0106 is in contact with the smoke.

In some embodiments, a method for manufacturing smoked food comprises:

1) burning wood to produce smoke at a first location (e.g., in fluid communication with a conduit, in a first volume, in a first chamber, in a first space, in a smoker box or any combination thereof), for example, in a controlled manner (e.g., using an electric heating element);

2) conveying the smoke to a second location (e.g., a second volume, a second space, second chamber, agitator, rotary drum, cold-smoker apparatus, or any combination thereof), for example, using the conduit, a plurality of conduits comprising the conduit, a smoke distribution manifold, or any combination thereof; and

3) providing fluid communication between a food at the second location and the smoke (e.g., smoking the food or contacting the food with the smoke) to provide a smoked food, optionally the smoking step occurring for 1-5 minutes (or 1 to 3 minutes) at ambient temperature (e.g., 0° C. to 57° C., or 10 to 40° C., or 15 to 30° C.).

In some embodiments, the smoked food may be a finished food product. In some embodiments, seasoning can be applied to the food before smoking, seasoning can be applied to the food during smoking, or the seasoning can be applied to the resulting smoked food, thereby providing a finished food product.

In some embodiments, the moisture content of the smoked food or finished food product prior to packaging is no more than 3% to provide crispiness over the duration of product's shelf life.

In some embodiments, the wood used to produce the smoke (e.g., hickory, mesquite, cherry, applewood, oak, or any combination thereof) is pre-treated by being placed in contact with water or an aqueous solution comprising water, with or without flavors (e.g., natural flavors), for 1-2 hours prior to burning.

In some embodiments, the wood is burned at the first location (e.g., in a “cold smoker” box) using an electric heating element, which can be provided with a thermostat to control the temperature at the first location, the temperature of the heating element, the temperature at which the wood is burned, the temperature at which smoke is created, or any combination thereof.

When the wood smoke is created, a flue damper can be opened on the smoker box to allow smoke to flow to the second location (e.g., “cold smoker” apparatus) where the food is positioned for smoking. As the smoke flows to the second location, it can cool and the degree that the smoke cools can be controlled by, for example, controlling the length of a conduit (e.g., pipe or duct) or plurality of conduits; the cross-sectional area or diameter of the conduit or plurality of conduits; the velocity of the smoke in the conduit or plurality of conduits; the residence time of the smoke in the conduit or plurality of conduits; the turbulence of a fluid (e.g., air) carrying smoke inside the conduit; the presence or absence of structural features, for example, baffles, elbows, valves or mixers, which can control flow of a fluid carrying the smoke in the conduit or plurality of conduits; application of a insulation, a heater, or a cooler to the conduit or plurality of conduits; or the surface area of the conduit or plurality of conduits, the temperature of air in contact with the conduit or plurality of conduits, or any combination thereof.

In some embodiments, during the transfer of smoke from the smoker box to the “cold smoker” apparatus, the smoke cools down to nearly ambient temperature thus eliminating the exposure of snack foods to excessive heat that can burn/toast the product and accelerate rancidity during shelf life. Using a “cold smoker” apparatus can also allow for a lower moisture environment via controlled residence time to minimize prolonged exposure of a food (e.g., snack food) to moisture that can cause excessive staling (e.g., resulting in undesired texture attributes for a low-moisture snack foods).

In some embodiments, the final smoked food product is packaged in high barrier laminate flexible film with low moisture and oxygen transmission. This can be used to 1) retain a smoke aroma in the bag and/or 2) maintain product quality during shelf life, for example, by minimizing moisture pick up. Both of these characteristics can be desired by consumers of food products.

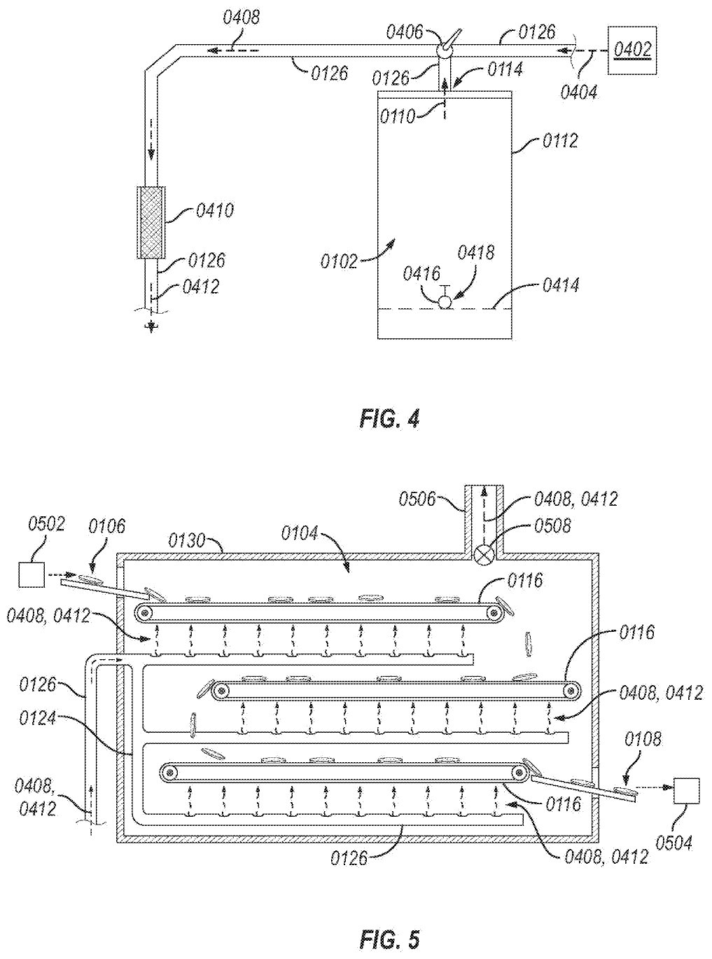

An example of a system and method for smoking a food product will now be described with reference to FIGS. 4 and 5. As part of the method, burning wood 0414 to produce smoke 0110 at a first location can comprise burning wood 0414 in a first chamber 0112, and the first location can be located in the first chamber 0112.

As illustrated in FIG. 4, the first chamber 0112 can comprise an air inlet 0418. In some embodiments, the first chamber 0112 can comprise a flow controller 0416 (e.g., valve) to control the flow rate of air entering the air inlet 0418 (e.g., to provide oxygen for combustion of the wood 0414 so that the smoke 0110 can be produced from the wood).

With further reference to FIG. 4, the first chamber 0112 can comprise an outlet 0114. Additionally, the first chamber 0112 can comprise: a flow controller 0406 (e.g., valve or valves). The flow controller 0406 can be (i) configured to control the flow of smoke, air or any combination thereof exiting the first chamber 0112; (ii) configured to control the flow of pressurized air (e.g., pressurized air being combined with the flow of smoke, air or any combination thereof exiting the first chamber 0112); or (iii) any combination thereof. As can be seen, the flow controller 0406 can be configured to discharge a flow 0408 of smoke 0110, air from the first chamber 0112, pressurized air 0404, or any combination thereof. This flow 0408 comprising smoke 0110 can then be conveyed into contact with food at a second location.

As illustrated in FIG. 4, the pressurized air can be provided by a pressurized air source 0402. Examples of pressurized air sources include fans, blowers, compressors, tanks storing pressurized air or any combination thereof.

As illustrated in FIG. 4, the step of conveying the smoke 0110 to a second location can comprise: combining a stream comprising the smoke 0110 (e.g., comprising the smoke 0110 and air from the first chamber 0112) with pressurized air 0404 (e.g., in a conduit 0126) to provide a flow 0408 comprising smoke 0110, air from the first chamber 0112, pressurized air 0404, or any combination thereof.

The step of conveying the smoke 0110 to a second location can comprise: filtering the smoke 0110 (e.g., using a filter 0410) before reaching the second location to provide a filtered flow 0408 comprising smoke 0110, air from the first chamber 0112, pressurized air 0404, or any combination thereof. The filtering the smoke 0110 can comprise filtering the flow 0408 that comprises the smoke 0110.

The step of providing fluid communication between the food 0106 at the second location and the smoke 0110 can comprise: discharging the smoke 0110 adjacent to, under, or above at least one conveyor 0116 that is conveying the food 0106 or any combination thereof (e.g., optionally the at least one conveyor 0116 is at least one belt conveyor 0116, at least one conveyor 0116 comprising apertures that are large enough to permit passage of the smoke 0110 through the apertures but are small enough that the food 0106 does not fall through the apertures, or any combination thereof). The at least one conveyor 0116 can comprise a plurality of conveyors 0116. The plurality of conveyors 0116 can be arranged to overlap each other vertically. The plurality of conveyors 0116 comprise a first conveyor and a second conveyor. The first conveyor can be positioned above the second conveyor for a length of the first conveyor and a corresponding length of the second conveyor. The first conveyor and the second conveyor can be configured so that smoke 0110 passing the second conveyor subsequently passes the first conveyor.

As illustrated in FIG. 5, the at least one conveyor 0116 can receive food 0106 (e.g., from a food source 0502). As an example, the first conveyor can receive the food 0106 at an upstream portion of the first conveyor. The first conveyor can convey the food 0106 to a downstream portion of the first conveyor. As illustrated, the first conveyor can be configured so that food 0106 can be gravity fed (e.g., can drop, slide or any combination thereof) from the first conveyor (e.g., the downstream portion of the first conveyor) to the second conveyor (e.g., the upstream portion of the second conveyor).

In some embodiments, the plurality of conveyors 0116 comprise a first conveyor, a second conveyor and a third conveyor. The second conveyor can be positioned above the third conveyor for a length of the second conveyor and a corresponding length of the third conveyor. The second conveyor and the third conveyor can be configured so that smoke 0110 passing the third conveyor subsequently passes the second conveyor and the first conveyor. The second conveyor can receive the food 0106 at a upstream portion of the second conveyor. The second conveyor can convey the food 0106 to a downstream portion of the second conveyor. As illustrated in FIG. 5, the second conveyor can be configured so that food 0106 can be gravity fed (e.g., can drop, slide or any combination thereof) from the second conveyor (e.g., the downstream portion of the second conveyor) to the third conveyor (e.g., the upstream portion of the third conveyor).

As illustrated in FIG. 5, the at least one conveyor 0116 (e.g., a last conveyor of the at least one conveyor, or the third conveyor) can discharge smoked food 0108 from a second space 0104 or a housing 0130 at least partially surrounding the second space 0104, the at least one conveyor 0116, or a combination thereof. The second space 0104 can comprise the second location. The at least one conveyor 0116 can be at least partially surrounded by a housing configured to contain the smoke 0110 and facilitate contact between the smoke 0110 and the food 0106. The at least one conveyor (e.g., a most downstream conveyor of the at last one conveyor, or the third conveyor) can discharge smoked food 0108 from the second space 0104 (e.g., comprising the second location). Optionally, the smoked food 0108 can be discharged to at least one unit 0504 comprising a seasoning applicator, a packaging unit, or any combination thereof.

With reference again to FIG. 5, the smoke 0110 can be conveyed to the food 0106 on the at least one conveyor 0116 through a manifold 0124, a conduit 0126 or a combination thereof.

The smoke 0110 (e.g., a flow 0408, 0412 comprising the smoke 0110, the flow optionally comprising air from the first location, air from the first space 0102, air from the first chamber 0112, the pressurized air 0404 or any combination thereof) can be discharged from the second location (e.g., from a second space 0104 comprising the second location) via a smoke vent 0506 of a housing 0130 for the second space 0104. The housing 0130 can form or partially form a second chamber surrounding the second space 0104. Optionally, a discharge flow rate (e.g., through a smoke vent 0506) of the smoke 0110 or a flow 0408, 0412 comprising the smoke can be controlled by a flow controller (e.g., damper, barometric damper 0508, valve or any combination thereof).

### Additional Embodiments

The following clauses include descriptive embodiments that are offered as further support of the disclosed invention:

1. A method for smoking food (e.g., a snack food, a farinaceous food, a chip, or potato chips), the method comprising:

burning wood to produce smoke at a first location (e.g., in fluid communication with a conduit, in a first volume, in a first space, in a first chamber, in a smoker box or any combination thereof), optionally in a controlled manner (e.g., using an electric heating element);

conveying the smoke to a second location (e.g., a second volume, second space, second chamber, agitator, a mixer, reorientation apparatus, inverter, tumbler, rotary drum, plurality of conveyor belts, cold-smoker apparatus, or any combination thereof or a housing therefor), optionally the conveying occurs via the conduit, a plurality of conduits comprising the conduit, a smoke distribution manifold, or any combination thereof; and

providing fluid communication between a food at the second location and the smoke (e.g., smoke at the first location) (e.g., smoking the food or contacting the food with the smoke) to provide a smoked food, optionally the providing fluid communication (e.g., smoking step or contacting step) occurring for 1-5 minutes (or 1-3 minutes) at ambient temperature (e.g., 0° C. to 57° C., or 10 to 40° C., or 15 to 30° C.).

2. The method of any preceding clause, optionally comprising the step of cooling the smoke to a temperature in the range from 0 to 124° C. before the smoke contacts the food at the second location, and optionally comprising the step of cooling the smoke to a temperature that is at least 0, 1, 2, 3, 4, 5, 10, 20, 30, 40, 50, 57, 60, 70, 79.4, 80, 90, 100, 110,120, 121, 121.1, 122, 123, or 124° C., no more than 1, 2, 3, 4, 5, 10, 20, 30, 40, 50, 57, 60, 70, 79.4, 80, 90, 100, 110, 120, 121, 121.1, 122, 123, or 124° C., or any combination thereof, before the smoke contacts the food at the second location.

3. The method of any preceding clause, optionally comprising the step of cooling the smoke to a temperature in the range from 0 to 57° C. before the smoke contacts the food at the second location, and optionally comprising cooling the smoke to nearly ambient temperature (e.g., within 25, 20, 15, 10 or 5° C. of ambient temperature) before the smoke contacts the food at the second location.

4. The method of any preceding clause, optionally comprising the step of contacting the food with the smoke for 1 to 5 minutes; and optionally comprising the step of contacting the food with the smoke for at least 10 seconds, 20 seconds, 30 seconds, 40 seconds, 50 seconds, 1 minute, 2 minutes, 3 minutes, 4 minutes, 5 minutes, 10 minutes, 15 minutes, 20 minutes, 25 minutes, 30 minutes, 35 minutes, 40 minutes, or 45 minutes; no more than 10 seconds, 20 seconds, 30 seconds, 40 seconds, 50 seconds, 1 minute, 2 minutes, 3 minutes, 4 minutes, 5 minutes, 10 minutes, 15 minutes, 20 minutes, 25 minutes, 30 minutes, 35 minutes, 40 minutes, or 45 minutes; or any combination thereof.

5. The method of any preceding clause, optionally the food having a moisture content of 0.5 to 3 wt. %, optionally the food having a moisture content of at least 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9 or 3.0 wt. %; no more than 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9 or 3.0 wt. %; or any combination thereof; and optionally the food having a water activity (e.g., as measured at 25° C. and 101.325 kPa) equal to at least 0.05, 0.06, 0.07, 0.08, 0.09, 0.1, 0.15, 0.2, 0.25, 0.3, or 0.35; no more than 0.05, 0.06, 0.07, 0.08, 0.09, 0.1, 0.15, 0.2, 0.25, 0.3, or 0.35; or any combination thereof.

6. The method of any preceding clause, the food being a snack food; a food to be packaged as a ready-to-eat food; a farinaceous food (e.g., a food comprising starch, comprising at least 5, 10, 20, 30, 40, 50, 60, 70, 80, 90, 95, 96, 97, 98, 99 or 100 wt. % starch, no more than 5, 10, 20, 30, 40, 50, 60, 70, 80, 90, 95, 96, 97, 98, 99 or 100 wt. % starch or any combination thereof); a chip (e.g., fried chip, baked chip, fried potato chip, baked potato chip, a plurality thereof, or any combination thereof); or any combination thereof.

7. The method of any preceding clause, optionally the food being recognized by consumers as crispy, crunchy or a combination thereof; optionally the food being fried, baked, extruded, direct-extruded, expanded, air-popped or any combination thereof.

8. The method of any preceding clause, the food being a chip (e.g., fried chip, baked chip, fried potato chip, baked potato chip, or any combination thereof).

9. The method of any preceding clause, optionally the smoked food having a moisture content of 0.5 to 3 wt. %; optionally the smoked food having a moisture content of at least 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2.1, 2.2, 2.3, 2.4, 2.5, 2.6, 2.7, 2.8, 2.9 or 3.0 wt. %; no more than 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2.1, 2.2, 2.3, 2.4, 2.5, 2.6, 2.7, 2.8, 2.9 or 3.0 wt. %; or any combination thereof; and optionally the smoked food having a water activity (e.g., as measured at 25° C. and 101.325 kPa) equal to at least 0.05, 0.06, 0.07, 0.08, 0.09, 0.1, 0.15, 0.2, 0.25, 0.3, or 0.35; no more than 0.05, 0.06, 0.07, 0.08, 0.09, 0.1, 0.15, 0.2, 0.25, 0.3, or 0.35; or any combination thereof.

10. The method of any preceding clause, wherein the wood is Hickory, Mesquite, Oak, Cherry, Applewood, or any combination thereof.

11. The method of any preceding clause, wherein the method comprises pre-treating the wood before burning the wood, wherein the pre-heating comprises placing the wood in contact with water or an aqueous solution comprising water, optionally with or without flavors (e.g, natural flavors), optionally for 1 to 2 hours, optionally the pre-treating occurs immediately before burning the wood.

12. The method of any preceding clause, optionally wherein the method comprises applying seasoning to the food before, during or after contacting the food with smoke, thereby providing a finished food product that comprises the smoked food; optionally wherein the finished food product food has a moisture content of 0.5 to 3 wt. %; optionally the finished food product having a moisture content of at least 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2.1, 2.2, 2.3, 2.4, 2.5, 2.6, 2.7, 2.8, 2.9 or 3.0 wt. %; no more than 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2.1, 2.2, 2.3, 2.4, 2.5, 2.6, 2.7, 2.8, 2.9 or 3.0 wt. %; or any combination thereof; and optionally the finished food product has a water activity (e.g., as measured at 25° C. and 101.325 kPa) equal to at least 0.05, 0.06, 0.07, 0.08, 0.09, 0.1, 0.15, 0.2, 0.25, 0.3, or 0.35; no more than 0.05, 0.06, 0.07, 0.08, 0.09, 0.1, 0.15, 0.2, 0.25, 0.3, or 0.35; or any combination thereof.

13. The method of any preceding clause, wherein the method comprises packaging the smoked food or the finished food product to provide a packaged food product, optionally in a package having a moisture vapor transmission rate (MVTR) (optionally at 25° C. and 101.325 kPa) from 0 to 1.5 g/m2/24 hr (or from 0.1 to 1.5 g/m2/24 hr) and optionally in a package having an oxygen transmission rate (OTR) from 0 to 10 cc/m2/24 hr (or from 1.5-10 cc/m2/24 hr), and optionally labelling the package with an expiration date or recommended date by which to consume the smoked food or finished food product, the expiration date or recommended date being at least 30, 60, 90, 120, 150, or 180 days from the date of the packaging step, no more 30, 60, 90, 120, 150, or 180 days from the date of the packaging step, or any combination thereof.

14. The method of any preceding clause, wherein the step of burning the wood to produce the smoke at the first location comprises burning the wood in a first chamber (e.g., smoker box), optionally wherein the first chamber is provided with an outlet that can be opened to permit smoke to be discharged from the first chamber, closed to impede passage of the smoke from the first chamber, opened partially to a variable extent, thereby providing control of the mass or volumetric flow rate of smoke discharged from the first chamber, or any combination thereof.

15. The method of any preceding clause, wherein the wood is burned using an electric heating element (e.g., only using an electric heating element or a plurality of electric heating elements), and optionally the electric heating element or plurality of electric heating elements is provided with a thermostat to control the temperature at the first location, the temperature of the heating element, the temperature at which the wood is burned, the temperature at which smoke is created, or any combination thereof.

16. The method of any preceding clause, wherein the conveying step comprises conveying the smoke to the second location via a manifold in fluid communication with a first chamber at the first location, the manifold in fluid communication with a plurality of conduits, each conduit in fluid communication with the second location (e.g., the second space), optionally the second space being at least partially bounded by an agitator (e.g., a mixer, reorientation apparatus, inverter, tumbler, rotary drum, plurality of conveyor belts, or any combination thereof) or housing for the agitator, the agitator configured to facilitate the application of seasoning to the food while the food is in contact with the smoke.

17. The method of any preceding clause, comprising conveying the food to the second location on a conveyor (e.g., conveyor belt, endless conveyor belt), optionally the conveyor belt configured to deliver the food to an agitator (e.g., a mixer, reorientation apparatus, inverter, tumbler, rotary drum, plurality of conveyor belts, or combination thereof), the agitator optionally comprising a housing configured to contain the smoke, and optionally the agitator (optionally with the housing) is configured to facilitate the application of seasoning to the food while the food is in contact with the smoke.

18. The method of any preceding clause:

optionally wherein the burning wood to produce smoke at a first location comprises burning wood in a first chamber;

optionally wherein the first chamber comprises an air inlet;

optionally wherein the first chamber comprises a flow controller (e.g., valve) to control the flow rate of air entering the air inlet (e.g., to provide oxygen for combustion of the wood so that the smoke can be produced from the wood);

optionally wherein the first chamber comprises an outlet;

optionally wherein the first chamber comprises: a flow controller (e.g., valve or valves); optionally wherein the flow controller is (i) configured to control the flow of smoke, air or any combination thereof exiting the first chamber; (ii) configured to control the flow of pressurized air (e.g., pressurized air being combined with the flow of smoke, air or any combination thereof exiting the first chamber); or (iii) any combination thereof; optionally wherein the flow controller is configured to discharge a flow of smoke, air from the first chamber, pressurized air, or any combination thereof;

optionally the pressurized air is provided by a pressurized air source;

optionally the conveying the smoke to a second location comprises: combining a stream comprising the smoke (e.g., comprising the smoke and air from the first chamber) with pressurized air (e.g., in a conduit) to provide a flow comprising smoke, air from the first chamber, pressurized air, or any combination thereof;

optionally the conveying the smoke to a second location comprises: filtering the smoke (e.g., using a filter) before reaching the second location to provide a filtered flow comprising smoke, air from the first chamber, pressurized air, or any combination thereof; optionally the filtering the smoke comprises filtering a flow comprising the smoke, optionally the flow comprising air from the first location, air from the first space, air from the first chamber, the pressurized air or any combination thereof) to provide a filtered flow (e.g., filtered smoke);

optionally the providing fluid communication between the food at the second location and the smoke comprises: discharging the smoke adjacent to at least one conveyor that is conveying the food, under at least one conveyor that is conveying the food, or above at least one conveyor that is conveying the food, or any combination thereof, optionally the at least one conveyor is at least one belt conveyor, at least one conveyor comprising apertures that are large enough to permit passage of the smoke through the apertures but are small enough that the food does not fall through the apertures, or any combination thereof); optionally the at least one conveyor comprises a plurality of conveyors; optionally the plurality of conveyors being arranged to overlap each other vertically; optionally the plurality of conveyors comprise a first conveyor and a second conveyor; optionally the first conveyor positioned above the second conveyor for a length of the first conveyor and a corresponding length of the second conveyor; optionally the first conveyor and the second conveyor are configured so that smoke passing the second conveyor subsequently passes the first conveyor; optionally the at least one conveyor receives food (e.g., from a food source); optionally the first conveyor receives the food at an upstream portion of the first conveyor; optionally the first conveyor conveys the food to a downstream portion of the first conveyor; optionally the first conveyor is configured so that food can be gravity fed (e.g., can drop, slide or any combination thereof) from the first conveyor (e.g., the downstream portion of the first conveyor) to the second conveyor (e.g., the upstream portion of the second conveyor);

optionally the plurality of conveyors comprise a first conveyor, a second conveyor and a third conveyor; optionally the second conveyor positioned above the third conveyor for a length of the second conveyor and a corresponding length of the third conveyor; optionally the second conveyor and the third conveyor are configured so that smoke passing the third conveyor subsequently passes the second conveyor and optionally the first conveyor; optionally the second conveyor receives the food at a upstream portion of the second conveyor; optionally the second conveyor conveys the food to a downstream portion of the second conveyor; optionally the second conveyor configured so that food can be gravity fed (e.g., can drop, slide or any combination thereof) from the second conveyor (e.g., the downstream portion of the second conveyor) to the third conveyor (e.g., the upstream portion of the third conveyor); optionally the at least one conveyor (e.g., a last conveyor of the at last one conveyor, or the third conveyor) discharges smoked food from a second space or a housing at least partially surrounding the second space, the at least one conveyor, or a combination thereof; optionally the second space comprising the second location; optionally the at least one conveyor is at least partially surrounded by a housing configured to contain the smoke and facilitate contact between the smoke and the food; optionally the at least one conveyor (e.g., a most downstream conveyor of the at last one conveyor, or the third conveyor) discharges smoked food from a second space (e.g., comprising the second location) optionally to at least one unit comprising a seasoning applicator, a packaging unit, or any combination thereof;

optionally the smoke is conveyed to the food on the at least one conveyor through a manifold, a conduit or a combination thereof;

optionally the smoke (e.g., a flow, comprising the smoke, the flow optionally comprising air from the first location, air from the first space, air from the first chamber, the pressurized air or any combination thereof) is discharged from the second location (e.g., from a second space comprising the second location) via a smoke vent of a housing for the second space; optionally the housing forms or partially forms a second chamber surrounding the second space; optionally a discharge flow rate (e.g., through a smoke vent) of the smoke or a flow, comprising the smoke can be controlled by a flow controller (e.g., damper, barometric damper, valve or any combination thereof).

19. The method of any preceding clause, comprising any feature or combination of features described in this disclosure.

20. A system comprising any equipment or any combination of equipment used to perform any method described in this disclosure, the equipment being configured to perform the method.

Although embodiments have been described in this disclosure, including for example the drawings, using components with specific shapes, the components described are not limited to the respective shapes shown in the drawings. For example, in some embodiments squared components can be replaced with rounded components or vice versa while maintaining the desired function of the devices.

Although embodiments have been described in this disclosure, including for example the drawings, using specific dimensions and angles, in other embodiments, any dimension or selection of dimensions can be changed (either increased or decreased in size) in additional embodiments, in accordance with any principles described in this disclosure or known to a person having ordinary skill in the art.

Although embodiments have been described using the word “comprising,” additional embodiments can be created by replacing the word “comprising” with “consisting essentially of” or “consisting of.” Additional embodiments can be created by replacing the word “comprising,” with comprising at least 1, 2, 3, 4, 5, 10, 20, 30, 40, 50, 60, 70, 80, 90, 95, 96, 97, 98, 99 or 100 wt. % and/or no more than 1, 2, 3, 4, 5, 10, 20, 30, 40, 50, 60, 70, 80, 90, 95, 96, 97, 98, 99 or 100 wt. % of the component or components described.

Although embodiments have been described using a first range with a first set of end points, additional embodiments can be created by replacing the first range with a narrower range whose endpoints are selected from any value contained in the first range.

Some embodiments have been described using optional elements. One of the optional elements, a selection of any of the optional elements, or all of the optional elements can be included in an embodiment, but inclusion of the optional elements in the embodiment is not required. Additionally, any combination of the optional elements can be included in the embodiment.

Although the invention hereof has been described by way of preferred embodiments, it will be evident that other adaptations and modifications can be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of the invention.

1. A method for smoking a farinaceous food, the method comprising:
burning wood to produce smoke at a first location in a first space;
conveying the smoke to a second location in a second space;
providing fluid communication between the farinaceous food in the second space and the smoke to provide a smoked food, the smoked food having a water activity, as measured at 25° C. and 101.325 kPa, equal to 0.05 to 0.35; and
packaging the smoked food to provide a packaged food.

2. The method of claim 1, comprising the step of cooling the smoke to a temperature in the range from 10 to 124° C. before the smoke contacts the farinaceous food at the second location.

3. The method of claim 1, comprising the step of cooling the smoke to a temperature in the range from 10 to 57° C. before the smoke contacts the farinaceous food at the second location.

4. The method of claim 2, comprising the step of contacting the farinaceous food with the smoke for 1 to 5 minutes.

5. The method of claim 1, the farinaceous food having a moisture content of 0.5 to 3 wt. %.

6. The method of claim 1, the farinaceous food comprising at least 40 wt. % starch and up to 100 wt. % starch.

7. The method of claim 1, the farinaceous food being a fried food, baked food, extruded food, direct-extruded food, expanded food, air-popped food or any combination thereof.

8. The method of claim 1, the farinaceous food being a baked or fried chip.

9. The method of claim 1, the smoked food having a moisture content of 0.5 to 3 wt. %.

10. The method of claim 1, wherein the wood is Hickory, Mesquite, Oak, Cherry, Applewood, or any combination thereof.

11. The method of claim 1, wherein the method comprises pre-treating the wood before burning the wood, wherein the pre-treating comprises placing the wood in contact with water or an aqueous solution comprising water for 1 to 2 hours.

12. The method of claim 1, wherein the method comprises applying seasoning to the farinaceous food before, during or after contacting the farinaceous food with smoke, thereby providing a finished food product that comprises the smoked food.

13. The method of claim 12, wherein the method comprises packaging the finished food product.

14. The method of claim 1, wherein the step of burning the wood to produce the smoke at the first location comprises burning the wood in a first chamber.

15. The method of claim 14, wherein the wood is burned using an electric heating element, and optionally the electric heating element is provided with a thermostat to control the temperature at the first location, the temperature of the heating element, the temperature at which the wood is burned, the temperature at which smoke is created, or any combination thereof.

16. The method of claim 15, wherein the conveying step comprises conveying the smoke to the second location via a manifold in fluid communication with the first chamber at the first location, the manifold being in fluid communication with a plurality of conduits, each conduit being in fluid communication with the second space, the second space being at least partially bounded by a rotary drum configured to facilitate the application of seasoning to the farinaceous food while the farinaceous food is in contact with the smoke.

17. The method of claim 1, comprising conveying the farinaceous food to the second location on a conveyor belt, the conveyor belt configured to deliver the farinaceous food to an agitator comprising a housing configured to contain the smoke, the agitator configured to facilitate the application of seasoning to the farinaceous food while the farinaceous food is in contact with the smoke.

18. The method of claim 14, wherein the first chamber is provided with an outlet that can be opened to permit smoke to be discharged from the first chamber and closed to impede passage of the smoke from the first chamber.

19. (canceled)

20. (canceled)

21. (canceled)

22. A method for smoking a farinaceous food, the farinaceous food being a baked or fried chip, the farinaceous food comprising at least 40 wt. % starch and up to 100 wt. % starch, the method comprising:
burning wood to produce smoke at a first location in a first space;
conveying the smoke to a second location in a second space;
cooling the smoke to a temperature in the range from 10 to 124° C. before the smoke contacts the farinaceous food at the second location, an inverter being located at the second location, the inverter being a multi-pass conveyor;
providing a smoked food by: (i) providing fluid communication between the farinaceous food in the second space and the smoke, the providing fluid communication comprising contacting the food with the smoke for 1 to 5 minutes, and (ii) using the multi-pass conveyor to reorient the farinaceous food from being positioned on a first set of surfaces of the farinaceous food to being positioned on a second set of surfaces of the farinaceous food, thereby facilitating exposure of a plurality of surfaces of the farinaceous food to the smoke; the smoked food having a water activity, as measured at 25° C. and 101.325 kPa, equal to 0.05 to 0.35; and the smoked food having a moisture content of 0.5 to 3 wt. %; and
packaging the smoked food to provide a packaged food.

23. The method of claim 4, wherein an inverter is located at the second location, the method comprising:
using the inverter to reorient the farinaceous food from being positioned on a first set of surfaces of the farinaceous food to being positioned on a second set of surfaces of the farinaceous food, thereby facilitating exposure of a plurality of surfaces of the farinaceous food to the smoke.
